(19) United States
(12) Patent Application Publication
(10) Pub. No.: US 2012/0012788 A1
(43) Pub. Date: Jan. 19, 2012

(54) PHOSPHOR, IMAGE DISPLAYING APPARATUS, AND MANUFACTURING METHOD THEREOF

(75) Inventor: Daisuke Sasaguri, Yokohama-shi (JP)

(73) Assignee: CANON KABUSHIKI KAISHA, Tokyo (JP)

(21) Appl. No.: 13/152,717

(22) Filed: Jun. 3, 2011

(30) Foreign Application Priority Data
Jul. 13, 2010 (JP) 2010-158607

(51) Int. Cl. C09K 11/84

(52) U.S. Cl. 252/301.4 S

(57) ABSTRACT

The present invention, which aims to obtain, in a Ga₂S₄:Eu phosphor, high luminance even when a particle size is set to 1000 nm or less, is characterized by a step of forming a raw material particle including a constituent component of a host material except a sulfur component and a constituent component of an activator in a composition ratio in the phosphor; a step of forming an amorphous precursor particle by heating and cooling the raw material particle by thermal plasma; and a step of baking the precursor particle in a sulfurization atmosphere to set the particle size to 1000 nm or less and a crystallite size to 60% or more of the particle size.

### BACKGROUND OF THE INVENTION

1. Field of the Invention

The present invention relates to a phosphor which is used in an image displaying apparatus such as a field emission display (FED), a plasma display panel (PDP), an organic LED display (OLED) or the like for displaying an image by light emission of the phosphor, an image displaying apparatus in which the phosphor is used, and manufacturing methods thereof. More specifically, the present invention relates to a phosphor in which thiogallate-based sulfide is used as a host material, an image displaying apparatus in which the phosphor is used, and manufacturing methods of the phosphor and the image displaying apparatus.

2. Description of the Related Art

For example, as a conventional manufacturing method of a phosphor, Japanese Patent Application Laid-Open No. H07-292354 discloses a method of manufacturing a phosphor of a particle diameter 0.05 μm to 2 μm by processing as a raw material an Y₂O₂S:Eu phosphor of an average particle diameter 3 μm by high-temperature plasma and then cooling the processed raw material.

Moreover, U.S. Pat. No. 6,875,372 discloses a method of manufacturing a particulate SrGa₂S₄:Eu phosphor by spraying a solution of raw material in a high-temperature furnace to form a precursor particle of SrGa₂O₄:Eu, classifying the formed precursor particles, and then thermally processing the obtained precursor particles in hydrogen sulfide.

Incidentally, a size of one pixel becomes small as a high-definition image displaying apparatus progresses, whereby a small particle size is required for a phosphor. More specifically, a phosphor which can obtain high luminance in a particle size of 1000 nm or less is required.

However, in both the Y₂O₂S:Eu phosphor and the SrGa₂O₄:Eu phosphor conventionally used as described above, there is a problem that high luminance cannot be obtained particularly in the particle size of 1000 nm or less. Here, the phosphor disclosed in U.S. Pat. No. 6,875,372 is common with the phosphor in the present invention in the point that thiogallate-based sulfide is used as the host material. However, as apparent from later-described comparative examples, since the crystallite size is small in regard to the particle size, it is believed that this causes insufficient luminance in the conventional phosphors.

The present invention aims to provide a phosphor in which high luminance can be obtained even if the particle size is set to 1000 nm or less, and also to provide an image displaying apparatus which can display a high-definition and bright image by using the relevant phosphor.

### SUMMARY OF THE INVENTION

A first aspect of the present invention is to provide a manufacturing method of a phosphor which includes a host material of thiogallate-based sulfide represented by a general formula AGa₂S₄ (where, A is Ca, Sr or Ba) and an activator, the method comprising the steps of:

(a) forming a raw material particle including a constituent component of the host material except a sulfur component and a constituent component of the activator in a composition ratio in the phosphor;

(b) forming an amorphous precursor particle by heating the raw material particle by thermal plasma and cooling the heated raw material particle; and

(c) baking the precursor particle in a sulfurization atmosphere to set a particle size to 1000 nm or less and a crystallite size to 60% or more of the particle size.

A second aspect of the present invention is to provide an image displaying apparatus in which plural pixels are constituted by phosphors provided to be able to selectively emit light, and which displays an image by causing the pixels to selectively emit light, wherein the pixels are constituted by the phosphors manufactured by the manufacturing method of the phosphor according to the above fist aspect of the present invention.

A third aspect of the present invention is to provide a phosphor wherein a particle size is 1000 nm or less, a crystallite size is 60% or more of the particle size, and a host material is thiogallate-based sulfide represented by a general formula AGa₂S₄ (where, A is Ca, Sr or Ba).

A fourth aspect of the present invention is to provide an image displaying apparatus in which plural pixels are constituted by phosphors provided to be able to selectively emit light, and which displays an image by causing the pixels to selectively emit light, wherein the pixels are the phosphors according to the above third aspect of the present invention.

In the manufacturing method of the phosphor according to the present invention, it is possible to obtain the amorphous precursor particle on a nanoscale by the step (b), and it is possible to improve crystallization while performing sulfuration. Consequently, it is possible to obtain the phosphor of which crystallinity is high and in which the particle diameter is 1000 nm or less. Since the crystal size of the phosphor according to the present invention is large, it is possible to obtain high luminance even if the particle size is 1000 nm or less. For this reason, the image displaying apparatus according to the present invention and the image displaying apparatus obtained by the manufacturing method of the image displaying apparatus according to the present invention can achieve high-definition and bright image display.

Further features of the present invention will become apparent from the following description of exemplary embodiments with reference to the attached drawings.

### BRIEF DESCRIPTION OF THE DRAWINGS

FIG. 1 is a partially cut-away schematic perspective view illustrating an overall constitution of an example of an image displaying apparatus according to the present invention.

FIG. 2A is a schematic cross-section view illustrating an enlarged part of a face plate.

FIG. 2B is an enlarged schematic view illustrating a phosphor.

### DESCRIPTION OF THE EMBODIMENTS

Preferred embodiments of the present invention will now be described in detail with reference to the attached drawings.

A phosphor according to the present invention is characterized in that a particle size is 1000 nm or less, a crystallite size is 60% or more of the particle size, and a host material is thiogallate-based sulfide represented by a general formula AGa₂S₄ (where, A is Ca, Sr or Ba).

The particle size in the present invention indicates D50 (median diameter) which can be obtained by measuring a particle size distribution. The D50 can be measured from, for example, a dispersion solution obtained by dispersing phosphors in ethanol, by using “ZETASIZER (Nano-ZS)” manufactured by Malvern instruments Ltd. The phosphor according to the present invention exhibits higher luminance as compared with a conventional phosphor if it has the same particle size as that of the conventional phosphor, in such the particle size equal to 1000 nm or less, which can be easily used in a high-definition image displaying apparatus. However, as the particle size becomes a small size, the luminance which can be obtained tends to be more deteriorated. When the particle size becomes to be less than 300 nm, although the higher luminance can be obtained as compared with the conventional phosphor having the same particle size, the luminance tends to become insufficient luminance in case of using such phosphor for an image displaying apparatus. Therefore, it is preferable that the particle size of the phosphor according to the present invention is in a level of 1000 nm or less and 300 nm or more.

A crystallite means a maximum group which can be regarded as a monocrystal. In a case where the particle size of the phosphor is larger than the crystallite size, the phosphor is in a state that a crystallite and an amorphous material are mixed in one phosphor particle or in a polycrystalline state. As the crystallite size comes closer to the particle size, an amorphous region or a polycrystalline region in the one phosphor particle decreases, and a ratio of a monocrystalline region increases. The crystallite size of the phosphor in the present invention is such the size, which is 60% or more of the particle size. Due to a fact that the particle size of the phosphor in the present invention is 1000 nm or less, an upper limit of the crystallite size in the present invention inevitably becomes 1000 nm.

The crystallite size can be obtained typically from an X-ray diffraction measurement. The crystallite size can be calculated by a method called a Scherrer method from a profile of diffraction peaks. A Scherrer's equation is expressed by the following general formula (I). In the formula (I), a symbol d denotes a crystallite size, a symbol K denotes a constant (0.9), a symbol λ denotes a measured X-ray wavelength (Cu: 15.4058 nm), a symbol β denotes a half width at half maximum of a diffraction peak and a symbol θ denotes a Bragg angle formed between a diffraction surface and a diffraction peak.

d=K·λ/β·cos θ (1)

The X-ray diffraction measurement is performed by using a sample obtained by filling up the phosphor powder in a standard cell. In a particle, in which the crystallite size is larger than 100 nm, the crystallite size or crystallinity can be analyzed by a method of TEM (Transmission Electron Microscope) observation, electron beam diffraction analysis or the like.

Although the host material of phosphor according to the present invention is represented by a general formula AGa₂S₄ (where, A is Ca, Sr or Ba), it is preferable to use the SrGa₂S₄ judging from a fact that the high luminance can be easily obtained. As an activator, although, for example, Eu, Ce or the like can be used, it is preferable to use Eu also judging from a fact that the high luminance can be easily obtained. The Ce or Eu is added by replacing a part of atoms represented by the symbol A. Although the concentration of Ce or Eu can be selected, for example, from a range of 0.1% to 15% for the number of atoms represented by the symbol A, it is preferable to select from a range of 0.5% to 7% judging from a fact that the high luminance can be easily obtained.

The above-described phosphor according to present invention can be manufactured by passing through following processes (a), (b) and (c). The process (a) is such a process, where the raw material particle, which contains constituent components of the host material excepting a sulfur component and constituent components of the activator at a predetermined composition ratio (composition ratio in the above-described phosphor), is formed. The process (b) is such a process, where an amorphous precursor particle is formed by heating the above-described raw material particle by the thermal plasma and then cooling the raw material particle. The process (c) is such a process, where the above-described precursor particle is baked in a sulfurization atmosphere and the crystallite size is set to 60% or more of the particle size.

First, in the process (a), the weight (gram) of respective raw materials is measured and the raw materials are mixed by treating the respective single components or the compound containing respective components as the raw materials such that the A component, the Gaₜ component and the activator component constituting the phosphor become to have such the composition ratio equivalent to that in the phosphor to be formed, and then the mixed raw materials are baked.

For example, in case of forming the SrGa₂S₄: Eu, strontium carbonate (SrCO₃), gallium oxide (Ga₂O₃) and europium chloride (EuCl₃) can be used as the row material. In a case where a blending amount of Eu is set to 3 at % (3/100 atom of Eu is blended for 1 mol of Sr) for the molar concentration of Sr, the weight of powder of these raw materials is measured and these powders are mixed such that molar composition ratio between Sr, Ga and Eu becomes a ratio of 0.97:2:0.03 and then the mixed powder are baked.

As for the baking, it is suitable if particles, which have uniformly diffused Sr, Ga and Eu, are formed, and the baking is performed at the temperature of 900° C. to 1200° C. for 0.5 to 5 hours. It is preferable that the particle size of the raw material particle is in a range of 1 μm to 30 μm.

Next, in the process (b), a thermal plasma process is executed to the raw material particles by a high-frequency thermal plasma device and the precursor particles are formed. The precursor particles can be obtained as the nano-level particles by a process that the raw material particles are put in the thermal plasma generated at a plasma torch and formed into droplets and then the raw material particles are rapidly cooled from this droplet condition in a chamber. The plasma is generated by applying a high-frequency wave to the plasma torch. The frequency of the high-frequency wave to be used is in a range of 0.1 MHz to 5 MHz. It is suitable that the pressure in the torch is kept to become such a state, where the pressure is the atmospheric pressure or less, for example, the pressure can be set to such a range of 660 Pa to 100000 Pa. As the gas used for generating the plasma, argon, nitrogen, hydrogen, oxygen or the mixed gas thereof can be enumerated. By supplying the raw material particles together with a sufficient amount of carrier gas, the raw material particles can be rapidly cooled from the droplet condition. As for a supplying amount of the carrier gas, it is preferable that this supplying amount is set such that the average gas flow rate in the chamber becomes about 0.1 m/sec to 20 m/sec. Argon, nitrogen, hydrogen, oxygen or the mixed gas thereof can be used also as the carrier gas. The precursor particles are collected by a collecting filter connected to the chamber and a vacuum pump. The precursor particles of which the particle size is in a range of 8 nm to 50 nm can be obtained by adjusting the flow rate and power of the gas to be supplied to the high-frequency thermal plasma device. As the precursor particles, particles of which the size is 50 nm or less are preferable, and particles of which the size is 30 nm or less are more preferable.

In the process (c), the crystallization can be improved while performing the sulfuration by baking the above-described precursor particles in the sulfurization atmosphere. Consequently, the phosphors, of which the particle diameter is 1000 nm or less, excellent in the crystallinity can be formed. Specifically, the phosphors can be formed by a process that the above-described precursor particles are filled up in a quartz crucible or a quartz tray and heated while flowing the hydrogen sulfide gas.

It will be described by exemplifying a case where the weight of the raw material particles is measured and the raw material particles are mixed such that a molar composition ratio of Sr, Ga and Eu becomes a ratio of 0.97:2:0.03 and then the raw material particles are baked, thereby forming the SrGa₂S₄:Eu phosphor from the precursor particles obtained by executing a thermal plasma process to these baked raw material particles. The baking in the process (c) can be performed in the hydrogen sulfide gas atmosphere attenuated by, for example, argon or nitrogen at the temperature within a range of 530° C. to 1000° C. or so. In this baking method, when the baking is performed at the temperature of 590° C. (corresponding to the temperature in Example 9) for ten minutes, the SrGa₂S₄:Eu phosphor, of which the particle size is about 50 nm and the crystallite size is also about 50 nm, can be obtained. Similarly, when the baking is performed at the temperature of 900° C. for 40 minutes, the SrGa₂S₄:Eu phosphor, of which the particle size is about 1000 nm and the crystallite size is also about 1000 nm, can be obtained. In this manner, the particle size and the crystallite size of the phosphor particles can be controlled by changing the baking temperature and time, and a best baking condition can be properly selected from the particle size necessary for the respective uses. More preferable baking temperature is selected from a range of 590° C. to 900° C.

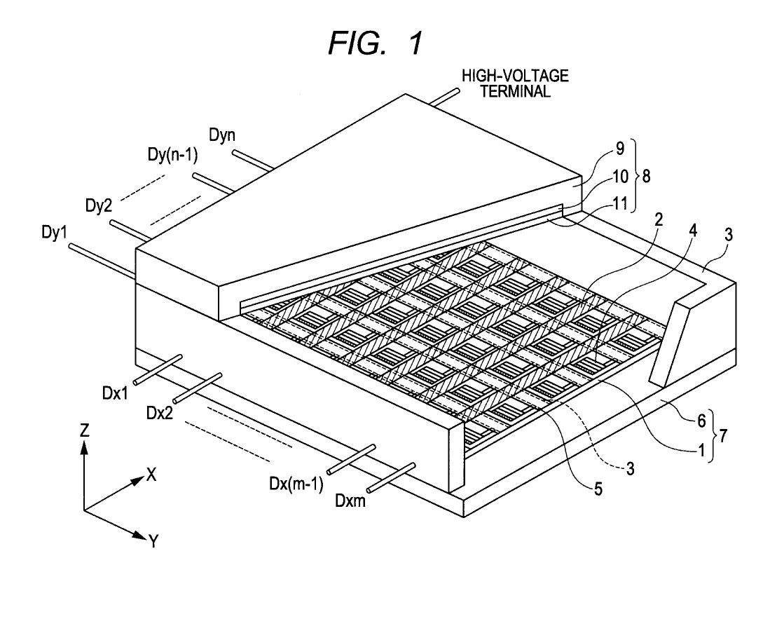

Next, an example of an image displaying apparatus according to the present invention will be described with reference to FIG. 1.

FIG. 1 shows an electron source substrate 1, an X-directional wiring 2, a Y-directional wiring 3, an electron-emitting device 4, and an interlayer insulating layer 5 which insulates a portion between the X-directional wiring 2 and the Y-directional wiring 3. As the electron-emitting device 4, an electron-emitting device such as a surface conduction electron-emitting device, a Spindt-type electron-emitting device, an MIM-type electron-emitting device, a carbon nano-tube electron-emitting device or the like can be used. A rear plate 7 is constituted by the electron source substrate 1 and an outside substrate 6 to which the electron source substrate 1 is fixed. A phosphor substrate (face plate) 8 is composed of a phosphor 10 and a metal back 11 serving as an anode electrode, which are formed on an inner surface of a transparent substrate 9 constituted by a glass or the like. The rear plate 7 and the face plate 8 are fixed to a support frame 3 through the medium of a frit glass or the like, and an internal space is sealed. Since the outside substrate 6 is provided for the purpose of mainly reinforcing the intensity of the electron source substrate 1, in a case where the electron source substrate 1 itself has the sufficient intensity, the outside substrate 6, which is a separable member, is not necessary, and the electron source substrate 1 constitute the rear plate 7 by itself. By arranging a support member (not illustrated) called a spacer between the face plate 8 and the rear plate 7, it can be also constituted to have the sufficient intensity for the atmospheric pressure.

The m X-directional wirings 2 are connected to terminals Dx1, Dx2, . . . Dxm. The n Y-directional wirings 3 are connected to terminals Dy1, Dy2, . . . Dyn (m and n are positive integers). The interlayer insulating layer 5 is provided between the m X-directional wirings 2 and the n Y-directional wirings 3, and both the wirings 2 and the wirings 3 are electrically separated.

A high voltage terminal is connected to the metal back 11, and, for example, the DC voltage of 10 kV is supplied. This DC voltage is the acceleration voltage used for giving sufficient energy to electrons emitted from the electron-emitting device to excite the phosphor 10.

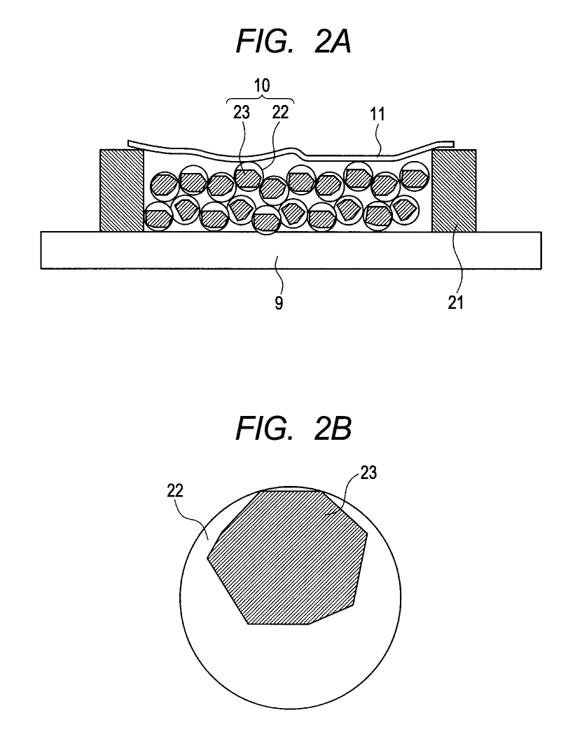

As illustrated in FIG. 2A, black matrixes 21 are formed on the transparent substrate 9. The phosphors 10 are laid on between the black matrixes 21, and the metal back 11 is formed on the phosphors 10. The phosphors 10 provided on a region surrounded by the black matrixes 21 constitute one pixel, and plural pixels identical to this one pixel are formed. These plural pixels are selectively made to emit light and an image is displayed by a process that the electron-emitting device 4 in FIG. 1 is selectively driven and the irradiation of an electron beam is selectively applied. As mentioned above, as for the phosphors 10, each of particles 22 has a crystallite 23. The phosphor 10 can obtain the high luminance by a fact that the particle 22 has the crystallite 23. It is required that the crystallite size is 60% or more of the particle size in order to obtain the high luminance, and it is preferable that the whole of the particle 22 becomes the crystallite 23.

In the image displaying apparatus according to the present invention, the plural pixels are constituted by the phosphors 10 which are provided capable of selectively emitting light, and in case of manufacturing the image displaying apparatus which displays an image by an process that the pixels are selectively made to emit light, this image displaying apparatus can be manufactured by constituting the pixels by using the phosphors 10 of the present invention. A process of laying the phosphors 10 on the transparent substrate 9 can be performed by a manner that the mixture obtained by mixing the phosphors 10 with the resin is arranged on the transparent substrate 9 by a method such as the discharge performed by a dispenser, the printing or an inkjet method thereafter the resin is eliminated by a heating process. As specific examples of the resin to be used, polyvinyl butyral, polyvinyl acetate, polyvinyl alcohol, cellulosic polymer, polyethylene, silicon polymer, polystyrene, acrylic polymer and the like can be enumerated. As cellulosic polymer, there are, for example, methyl cellulose, ethyl cellulose, hydroxyethyl cellulose and methylhydroxyethyl cellulose. As silicon polymer, there are, for example, polymethylsiloxane and polymethylphenylsiloxane.

Although an illustrated example is a case of using the electron-emitting device 4, if it is an image displaying apparatus which displays an image by a process that the pixels constituted by the phosphors 10 are selectively made to emit light, a PDP may be also available.

### Example 1

The SrGa₂S₄:Eu phosphor according to the present invention was formed by a manufacturing method of the present invention. As the raw materials, the strontium carbonate (SrCO₃) powder, the gallium oxide (Ga₂O₃) powder and the europium chloride (EuCl₃) powder were used, and these powders were mixed by using a mortar. At this time, the weight of the respective powders was measured so as to obtain the following composition ratio at a weight (gram) level such that a ratio between constituent components of the host material excepting a sulfur component and constituent components of an activator becomes a composition ratio in the phosphor to be formed, and then the powder was used. That is, the weight of the respective powders was measured such that the raw material of the host material before the sulfuration becomes SrGa₂O₄, and then the powder was used. The concentration of Eu was set to 3 at % for the molar concentration of Sr.

SrCO₃:Ga₂O₃:EuCl₃≈4.23:5.54:0.23

Next, the above-described mixed powder was put in an alumina crucible, which was set in atmosphere, and baked at the temperature of 1050° C. for 2 hours. Thus, the raw material particles were formed. When a particle size distribution of the raw material particles was measured, the D50 (median diameter) was 7.8 μm.

Next, the formed raw material particles were processed into the nano-sized particles by using a high-frequency thermal plasma method, and the precursor particles were formed. The oxygen gas was introduced in a high-frequency thermal plasma device at a flow rate of 80 L/min (symbol L denotes liters). In order to generate the plasma, a high-frequency oscillation coil was applied with the power of about 4 MHz and about 80 kVA, and the thermal plasma was generated. The above-described raw material particles were put in the thermal plasma device adjusted as above together with argon gas serving as carrier gas, and the precursor particles, which were formed by melting and cooling the raw material particles, were collected. As a result of observing the obtained particles by using an SEM (Scanning Electron Microscope), it was understood that the particle size was about 20 nm. In addition, as a result of analyzing a crystalline structure by using a method of XRD (X-ray diffraction), it was understood that the obtained particles were amorphous particles.

Next, the formed precursor particles were baked. As for the baking atmosphere, the precursor particles were baked at the temperature of 750° C. for 15 minutes in a hydrogen sulfide gas atmosphere attenuated to 3% by using argon, and then the phosphors were formed. As a result of observing the phosphors formed in this manner by using the SEM, it was understood that the particle size was 300 nm, and it was understood that the D50 was 300 nm in the measurement of a particle size distribution. In addition, as a result of analyzing a crystalline structure by using an X-ray diffraction device manufactured by Rigaku Corporation, it was confirmed that the crystalline structure of the phosphors was a monophase of the SrGa₂S₄ crystal. In addition, a main diffraction peak of the SrGa₂S₄ was selected from the obtained diffraction peak, and when the crystallite size was estimated by using the Scherrer's equation from a half width at half maximum of that main diffraction peak, it was understood that the crystallite size was 180 nm.

A light emission characteristic of the above-described phosphors was evaluated. The powder of 0.1 g was set in a vacuum container, and a pulsed electron beam was irradiated to the powder. A pulse width was set to 20 psec, a frequency was set to 100 Hz and an irradiation current density was set to 20 mA/cm². As a result of measuring the luminance by using a radiance meter, the luminance of 255 cd/m² was obtained with a state of emitting green light. If the luminance required in the image displaying apparatus is set to 210 cd/m² with a state of emitting green light, it may be said that the phosphors of this example can realize this required luminance. The forming conditions and the evaluated results are indicated in Table 1.

### Example 2

The precursor particles were formed under the same condition as that of the Example 1. Next, the formed precursor particles were baked under the same condition as that of the Example 1 regarding the baking atmosphere and the baking temperature but only the baking time was extended, and the phosphors were formed. The phosphors formed in this manner were evaluated by a method similar to that of the Example 1. The forming conditions and the evaluated results are indicated in Table 1.

Although the particle size of the phosphors formed in the Example 2 was the same as that of the Example 1, the crystallite size was larger as compared with the phosphors in the Example 1, and the luminance with a state of emitting green light was also increased. Judging from this fact, it may be said that the luminance can be increased with a state of emitting light of the same chromaticity by increasing the crystallite size in the phosphor particles. It may be said that the luminance required in the image displaying apparatus could be realized by the phosphors of this example.

### Comparative Example 1

The precursor particles were formed under the same condition as that of the Example 1. Next, the formed precursor particles were baked under the same condition as that of the Example 1 regarding the baking atmosphere and the baking temperature but only the baking time was shortened, and the phosphors were formed. The phosphors formed in this manner were evaluated by a method similar to that of the Example 1. The forming conditions and the evaluated results are indicated in Table 1.

Although the particle size of the phosphors formed in the Comparative Example 1 was the same as that of the Example 1, the crystallite size was smaller as compared with the phosphors in the Example 1, and the luminance was also decreased. Judging from this fact, it may be said that the luminance is decreased if the crystallite size in the phosphor particles is too small. The previously set luminance required in the image displaying apparatus could not be realized by the phosphors of the present comparative example.

Judging from the Examples 1 and 2 and the Comparative Example 1 described as above, in order to achieve the excellent luminance (210 cd/m² or more) when the particle size of the phosphors is 300 nm, it may be said that the crystallite size is required to be set to 60% or more for the particle size of the phosphors.

### Examples 3 and 4 and Comparative Example 2

The precursor particles were formed under the same condition as that of the Example 1. Next, the formed precursor particles were baked under such the condition, where the baking atmosphere was the same as that of the Example 1, the baking temperature was set to 780° C. and the respective baking times were set as indicated in Table 1, and the phosphors were formed. The phosphors formed in this manner were evaluated by a method similar to that of the Example 1. The forming conditions and the evaluated results are indicated in Table 1.

The particle size of the phosphor particles formed in the Examples 3 and 4 and the Comparative Example 2 was 500 nm, and this size was increased as compared with the case in the Example 1. The crystallite size of the phosphors became larger as the baking time became longer. The luminance was more increased with a state of emitting light of the same chromaticity as the crystallite size became larger. Judging from this fact, it may be said that the luminance can be increased by increasing the crystallite size in the phosphor particles. Judging from results in the Examples 3 and 4 and the Comparative Example 2, in order to achieve the excellent luminance (210 cd/m² or more) when the particle size of the phosphors is 500 nm, it may be said that the crystallite size is required to be set to 60% or more for the particle size of the phosphors.

### Examples 5 and 6 and Comparative Example 3

The precursor particles were formed under the same condition as that of the Example 1. Next, the formed precursor particles were baked under such the condition, where the baking atmosphere is the same as that of the Example 1, the baking temperature was set to 830° C. and the respective baking times were set as indicated in Table 1, and the phosphor particles were formed. The phosphor particles formed in this manner were evaluated by a method similar to that of the Example 1. The forming conditions and the evaluated results are indicated in Table 1.

The particle size of the phosphors formed in the Examples 5 and 6 and the Comparative Example 3 was 800 nm, and this size was increased as compared with a case in the Example 1. The crystallite size of the phosphors became larger as the baking time became longer. The luminance was also more increased with a state of emitting light of the same chromaticity as the crystallite size became larger. Judging from this fact, it may be said that the luminance can be increased by increasing the crystallite size in the phosphor particles. Judging from results in the Examples 5 and 6 and the Comparative Example 3, in order to achieve the excellent luminance (210 cd/m² or more) when the particle size of the phosphors is 800 nm, it may be said that the crystallite size is required to be set to 60% or more for the particle size of the phosphors.

### Examples 7 and 8 and Comparative Example 4

The precursor particles were formed under the same condition as that of the Example 1. Next, the formed precursor particles were baked under such the condition, where the baking atmosphere was the same as that of the Example 1, the baking temperature was set to 900° C. and the respective baking times were set as indicated in Table 1, and the phosphors were formed. The phosphors formed in this manner were evaluated by a method similar to that of the Example 1. The forming conditions and the evaluated results are indicated in Table 1.

The particle size of the phosphors formed in the Examples 7 and 8 and the Comparative Example 4 was 1000 nm, and this size was increased as compared with a case in the Example 1. The crystallite size of the phosphors became larger as the baking time became longer. The luminance was also more increased with a state of emitting light of the same chromaticity as the crystallite size became larger. Judging from this fact, it may be said that the luminance can be increased by increasing the crystallite size in the phosphor particles. Judging from results in the Examples 7 and 8 and the Comparative Example 4, in order to achieve the excellent luminance (210 cd/m² or more) when the particle size of the phosphors is 1000 nm, it may be said that the crystallite size is required to be set to 60% or more for the particle size of the phosphors.

Judging from results in the Examples 1 to 8 and the Comparative Examples 1 to 4 as described above, in order to achieve the excellent luminance (210 cd/m² or more) when the particle size of the phosphors is in a range of 300 nm to 1000 nm, it may be said that the crystallite size is required to be set to 60% or more for the particle size of the phosphors.

TABLE 1

| | Particle | Crystallite | Baking | Baking | Lumi- |
|---|---|---|---|---|---|
| | size | size | temperature | time | nance |
| | (nm) | (nm) | (° C.) | (min.) | (cd/m²) |
| Example 1 | 300 | 180 | 740 | 13 | 219 |
| Example 2 | 300 | 300 | 740 | 19 | 237 |
| Comparative | 300 | 160 | 740 | 7 | 128 |
| Example 1 | | | | | |
| Example 3 | 500 | 300 | 780 | 18 | 267 |
| Example 4 | 500 | 500 | 780 | 25 | 289 |
| Comparative | 500 | 270 | 780 | 6 | 168 |
| Example 2 | | | | | |
| Example 5 | 800 | 500 | 830 | 20 | 294 |
| Example 6 | 800 | 800 | 830 | 27 | 323 |
| Comparative | 800 | 430 | 830 | 8 | 192 |
| Example 3 | | | | | |
| Example 7 | 1000 | 600 | 900 | 25 | 334 |
| Example 8 | 1000 | 1000 | 900 | 40 | 350 |
| Comparative | 1000 | 550 | 900 | 12 | 199 |
| Example 4 | | | | | |

### Comparative Example 5

The phosphor particles were formed under the same condition as that of the Example 8 excepting a fact that the precursor particles were formed by a manufacturing method described in U.S. Pat. No. 6,875,372. Hereinafter, the manufacturing method based on the description in U.S. Pat. No. 6,875,372 will be described.

As the raw materials, Ga(NO₃)₃, Sr(NO₃)₂ and Eu(NO₃)₃ were mixed. At this time, the weight of these materials was measured such that the raw material of the host material to be obtained became SrGa₂O₄, and these materials were used. The concentration of Eu was set to 3 at % for the molar concentration of Sr. This raw material was sprayed into a furnace which was heated up to 800° C. under the atmospheric condition. The precursor particles formed by performing the spraying were collected, and the precursor particles of which the diameter was the same as those in Example 9 were classified.

Next, the formed precursor particles were baked under the same condition as that of the Example 8, and the phosphors were formed. The phosphors formed in this manner were evaluated by a method similar to that of the Example 1. The forming conditions and the evaluated results are indicated in Table 2. Judging from a result in the Comparative Example 5, it may be said that the excellent luminance cannot be obtained by the phosphors formed by a manufacturing method described in U.S. Pat. No. 6,875,372.

### Comparative Examples 6 and 7

The phosphors were formed under the same condition as that of the Comparative Example 5 excepting a point that the baking time was extended as indicated in Table 2, by using the precursor particles formed under the same condition as that of the Comparative Example 5. The phosphors formed in this manner were evaluated by a method similar to that of the Example 1. The forming conditions and the evaluated results are indicated in Table 2.

Judging from results in the Comparative Examples 6 and 7, it may be said that the excellent luminance cannot be obtained by the phosphors formed by the manufacturing method described in U.S. Pat. No. 6,875,372 because the crystallite size cannot be increased to 35% or more of the particle size. If the baking temperature is increased, since the particle size becomes larger, the phosphors particles of which the particle size is 1000 nm or less cannot be formed. Therefore, judging from results in Comparative Examples 5, 6 and 7, it may be said that the excellent luminance cannot be obtained by such the particle size which is 1000 nm or less, even if the manufacturing condition is changed, in the manufacturing method described in U.S. Pat. No. 6,875,372. The present inventors investigated a manufacturing method of the precursor particles in detail. As a result of this investigation, it was invented that the crystallite size could be increased to a large size by using amorphous precursor particles formed by a thermal plasma method and the excellent luminance could be obtained.

TABLE 2

| | Particle | Crystallite | Baking | Baking | Lumi- |
|---|---|---|---|---|---|
| | size | size | temperature | time | nance |
| | (nm) | (nm) | (° C.) | (min.) | (cd/m²) |
| Comparative | 1000 | 320 | 900 | 40 | 147 |
| Example 5 | | | | | |
| Comparative | 1000 | 350 | 900 | 50 | 155 |
| Example 6 | | | | | |
| Comparative | 1000 | 350 | 900 | 60 | 155 |
| Example 7 | | | | | |

### Example 9

The precursor particles were formed under the same condition as that of the Example 1. Next, the formed precursor particles were baked under such the condition, where the baking atmosphere was the same as that of the Example 1, the baking temperature was set to 590° C. and the baking time was set to 10 minutes, and the phosphors were formed. The phosphors formed in this manner were evaluated by a method similar to that of the Example 1. The forming conditions and the evaluated results are indicated in Table 3.

### Comparative Example 8

The precursor particles were formed under the same condition as that of the Comparative Example 5. Next, the formed precursor particles were baked under such the condition, where the baking atmosphere was the same as that of the Example 1, the baking temperature was set to 590° C. and the baking time was set to 10 minutes, and the phosphors were formed. The phosphors formed in this manner were evaluated by a method similar to that of the Example 1. The forming conditions and the evaluated results are indicated in Table 3.

### Comparative Example 9

The phosphors were formed by the manufacturing method described in Japanese Patent Application Laid-Open No. H07-292354. The phosphors were formed under the same condition as that of the Example 9 excepting the above manufacturing method. As the raw materials, the powders of SrS, Ga₂S₃ and EuS were mixed by using a mortar. At this time, the weight of these materials was measured such that the row material of the host material became SrGa₂S₄, and these materials were used. The concentration of Eu was set to 3 at % for the molar concentration of Sr. This mixed powder was put in an alumina crucible, which was set in atmosphere, and baked at the temperature of 1050° C. for 2 hours. When a particle size distribution of the obtained raw material particles was measured, the D50 (median diameter) was 7.8 μm.

Next, the formed raw material particles were processed into the nano-sized particles by using a high-frequency thermal plasma method, and the precursor particles were formed. Concretely, the argon gas was introduced in a high-frequency thermal plasma device at a flow rate of 80 L/min. In order to generate the plasma, a high-frequency oscillation coil was applied with the power of about 4 MHz and about 80 kVA, and the thermal plasma was generated. The above-described raw material particles were put in the thermal plasma device adjusted as mentioned above together with argon gas serving as carrier gas, and the raw material particles were melted and cooled. The particles formed in this manner were collected.

As a result of observing the collected particles by using an SEM (Scanning Electron Microscope), it was understood that the particle size was about 50 nm. In addition, as a result of analyzing a crystalline structure by using a method of XRD (X-ray diffraction), it was understood that the collected particles were amorphous materials. The phosphors formed in this manner were evaluated by a method similar to that of the Example 1. The forming conditions and the evaluated results are indicated in Table 3.

TABLE 3

| | Particle | | Baking | Baking | Lumi- |
|---|---|---|---|---|---|
| | size | Crystallite size | temperature | time | nance |
| | (nm) | (nm) | (° C.) | (min.) | (cd/m²) |
| Example 9 | 50 | 50 | 590 | 10 | 85 |
| Comparative | 50 | 15 | 590 | 10 | 23 |
| Example 8 | | | | | |
| Comparative | 50 | amorphous | none | none | 2 |
| Example 9 | | | | | |

Judging from results in the Example 9 and the Comparative Examples 8 and 9 as described above, it may be said that the luminance of the phosphors formed by the manufacturing method of the present invention can be more improved as compared with the phosphors formed by the manufacturing method described in the related art.

### Example 10

The CaGa₂S₄:Eu phosphor according to the present invention was formed. In the Example 10, as the raw materials, the calcium carbonate (CaCO₃) powder, the gallium oxide (Ga₂O₃) powder and the europium chloride (EuCl₃) powder were used, and these powders were mixed by using a mortar. At this time, the weight of the respective powders was measured so as to obtain the following composition ratio at a weight (gram) level such that a ratio between constituent components of the host material excepting a sulfur component and constituent components of an activator became a composition ratio in the phosphor to be formed. That is, the weights of the respective powders were measured such that the host raw material before the sulfuration became CaGa₂O₄, and then the powder was used. The concentration of Eu was set to 3 at % for the molar concentration of Ca. The phosphors were formed under the same condition as that of the Example 9 excepting the above description.

CaCO₃:Ga₂O₃:EuCl₃≈2.87:5.54:0.23

The phosphors formed in this manner were evaluated by a method similar to that of the Example 1. The forming conditions and the evaluated results are indicated in Table 3.

### Comparative Example 10

In the Comparative Example 10, as the raw materials, Ga(NO₃)₃, Ca(NO₃)₂ and Eu(NO₃)₃ were mixed. At this time, the weights of these materials were measured such that the host raw material before the sulfuration became CaGa₂O₄, and these materials were used. The phosphors were formed under the same condition as that of the Comparative Example 5 excepting the above description. The phosphors formed in this manner were evaluated by a method similar to that of the Example 1. The forming conditions and the evaluated results are indicated in Table 3.

### Comparative Example 11

In the Comparative Example 11, as the raw materials, the powders of CaS, Ga₂S₃ and EuS were mixed by using a mortar. At this time, the weights of these raw materials were measured such that the row material of the host row material became CaGa₂S₄, and these materials were used. The phosphors were formed under the same condition as that of the Comparative Example 9 excepting the above description. The phosphors formed in this manner were evaluated by a method similar to that of the Example 1. The forming conditions and the evaluated results are indicated in Table 4.

TABLE 4

| | Particle | | Baking | Baking | Lumi- |
|---|---|---|---|---|---|
| | size | Crystallite size | temperature | time | nance |
| | (nm) | (nm) | (° C.) | (min.) | (cd/m²) |
| Example 10 | 50 | 50 | 590 | 10 | 105 |
| Comparative | 50 | 15 | 590 | 10 | 28 |
| Example 10 | | | | | |
| Comparative | 50 | amorphous | none | None | 3 |
| Example 11 | | | | | |

Judging from results in the Example 10 and the Comparative Examples 10 and 11 as described above, it may be said that the luminance of the phosphors formed by the manufacturing method of the present invention can be more improved as compared with the phosphors formed by the manufacturing method described in the related art.

### Example 11

The BaGa₂S₄:Eu phosphor according to the present invention was formed. In the Example 11, as the raw materials, the barium carbonate (BaCO₃) powder, the gallium oxide (Ga₂O₃) powder and the europium chloride (EuCl₃) powder were used, and these powders were mixed by using a mortar. At this time, the weights of the respective powders were measured so as to obtain the following composition ratio at a weight (gram) level such that a ratio between constituent components of the host material excepting a sulfur component and constituent components of an activator became a composition ratio in the phosphor to be formed. That is, the weight of the respective powders was measured such that the raw material of the host material before the sulfuration became BaGa₂O₄, and then the powder was used. The concentration of Eu was set to 3 at % for the molar concentration of Ba. The phosphors were formed under the same condition as that of the Example 9 excepting the above description.

BaCO₃:Ga₂O₃:EuCl₃≈2.87:5.54:0.23

The phosphor particles formed in this manner were evaluated by a method similar to that of the Example 1. The forming conditions and the evaluated results are indicated in Table 3.

### Comparative Example 12

In the Comparative Example 12, as the raw materials, Ga(NO₃)₃, Ba(NO₃)₂ and Eu(NO₃)₃ were mixed. At this time, the weights of these materials were measured such that the raw material of the host material before the sulfuration became BaGa₂O₄, and these materials were used. The phosphors were formed under the same condition as that of the Comparative Example 5 excepting the above description. The phosphors formed in this manner were evaluated by a method similar to that of the Example 1. The forming conditions and the evaluated results are indicated in Table 4.

### Comparative Example 13

In the Comparative Example 13, as the raw materials, the powders of BaS, Ga₂S₃ and EuS were mixed by using a mortar. At this time, the weights of these materials were measured such that the row material of the host material became BaGa₂S₄, and these materials were used. The phosphors were formed under the same condition as that of the Comparative Example 9 excepting the above description. The phosphors formed in this manner were evaluated by a method similar to that of the Example 1. The forming conditions and the evaluated results are indicated in Table 5.

TABLE 5

| | Particle | Crystallite | Baking | Baking | Lumi- |
|---|---|---|---|---|---|
| | size | size | temperature | time | nance |
| | (nm) | (nm) | (° C.) | (min.) | (cd/m²) |
| Example 11 | 50 | 50 | 590 | 10 | 41 |
| Comparative | 50 | 15 | 590 | 10 | 14 |
| Example 12 | | | | | |
| Comparative | 50 | 4 | none | none | 1 |
| Example 13 | | | | | |

Judging from results in the Example 11 and the Comparative Examples 12 and 13 as described above, it may be said that the luminance of the phosphors formed by the manufacturing method of the present invention can be more improved as compared with the phosphors formed by the manufacturing method described in the related art.

### Example 12

The precursor particles were formed under the same condition as that of the Example 10. The formed precursor particles were baked at the baking temperature of 900° C. for 40 minutes, and the phosphors were formed. The phosphors formed in this manner were evaluated by a method similar to that of the Example 1. The forming conditions and the evaluated results are indicated in Table 6.

### Comparative Examples 14, 15 and 16

The precursor particles were formed under the same condition as that of the Comparative Example 10. The formed precursor particles were baked at the baking temperature of 900° C. for 40 minutes, 50 minutes and 60 minutes respectively, and the phosphors were formed. The phosphors formed in this manner were evaluated by a method similar to that of the Example 1. The forming conditions and the evaluated results are indicated in Table 6.

TABLE 6

| | Particle | Crystallite | Baking | Baking | Lumi- |
|---|---|---|---|---|---|
| | size | size | temperature | time | nance |
| | (nm) | (nm) | (° C.) | (min.) | (cd/m²) |
| Example 12 | 1000 | 1000 | 900 | 40 | 432 |
| Comparative | 1000 | 320 | 900 | 40 | 181 |
| Example 14 | | | | | |
| Comparative | 1000 | 350 | 900 | 50 | 195 |
| Example 15 | | | | | |
| Comparative | 1000 | 350 | 900 | 60 | 194 |
| Example 16 | | | | | |

The phosphors, of which the particle size exceeded 50 nm, could not be formed by the manufacturing method in Japanese Patent Application Laid-Open No. H07-292354. Therefore, judging from results in the Example 12 and the Comparative Examples 14, 15 and 16, it may be said that the luminance of the CaGa₂S₄ phosphors formed by the manufacturing method of the present invention can be more improved as compared with the phosphors formed by the manufacturing method described in the related art.

### Example 13

The precursor particles were formed under the same condition as that of the Example 11. The formed precursor particles were baked at the baking temperature of 900° C. for 40 minutes, and the phosphors were formed. The phosphors formed in this manner were evaluated by a method similar to that of the Example 1. The forming conditions and the evaluated results are indicated in Table 7.

### Comparative Examples 17, 18 and 19

The precursor particles were formed under the same condition as that of the Comparative Example 12. The formed precursor particles were baked at the baking temperature of 900° C. for 40 minutes, 50 minutes and 60 minutes respectively, and the phosphors were formed. The phosphors formed in this manner were evaluated by a method similar to that of the Example 1. The forming conditions and the evaluated results are indicated in Table 7.

TABLE 7

| | Particle | Crystallite | Baking | Baking | Lumi- |
|---|---|---|---|---|---|
| | size | size | temperature | time | nance |
| | (nm) | (nm) | (° C.) | (min.) | (cd/m²) |
| Example 13 | 1000 | 1000 | 900 | 40 | 220 |
| Comparative | 1000 | 320 | 900 | 40 | 92 |
| Example 17 | | | | | |
| Comparative | 1000 | 350 | 900 | 50 | 95 |
| Example 18 | | | | | |
| Comparative | 1000 | 350 | 900 | 60 | 95 |
| Example 19 | | | | | |

The phosphors, of which the particle size was 50 nm or more, could not be formed by the manufacturing method in Japanese Patent Application Laid-Open No. H07-292354. Therefore, judging from results in the Example 13 and the Comparative Examples 17, 18 and 19, it may be said that the luminance of the BaGa₂S₄ phosphors formed by the manufacturing method of the present invention can be more improved as compared with the phosphors formed by the manufacturing method described in the related art.

### Comparative Examples 20 and 21

The SrGa₂S₄:Eu phosphors having a large particle size were formed by two kinds of methods.

First, the precursor particles were formed under the same condition as that of the Example 1. Next, the formed precursor particles were baked under such the condition, where the baking atmosphere was the same as that of the Example 1, the baking temperature was set to 1000° C. and the baking time was set to two hours, and the phosphor particles were formed. The phosphor particles formed in this manner were evaluated by a method similar to that of the Example 1. The particle size was 3000 nm (3 μm), the crystallite size was 3000 nm, and the luminance was 394 cd/m².

On the other hand, the weight of the respective materials of the strontium sulfide powder, the gallium oxyhydroxide powder and the europium oxalate powder was measured and mixed such that a ratio between constituent components of the host material excepting a sulfur component and constituent components of an activator becomes a composition ratio in the phosphor to be formed. The concentration of Eu is set to 3 at % for the molar concentration of Sr. The powder obtained by mixing the above-described materials was baked at the temperature of 1000° C. for two hours under the hydrogen sulfide atmosphere, and the phosphors were formed. The phosphor particles formed in this manner were evaluated by a method similar to that of the Example 1. The particle size was 3000 nm (3 μm), the crystallite size was 3000 nm, and the luminance was 394 cd/m².

Judging from results in the Comparative Examples and 21, when the particle size becomes larger, the phosphors formed through the precursor particles obtained by executing the thermal plasma process and the phosphors formed by baking the above-described mixed powder under the hydrogen sulfide atmosphere without through the precursor particles also can obtain the equivalent crystallite size. Therefore, it may be said that almost no difference is found for the obtained luminance of respective cases.

### Example 14

The image displaying apparatus described above was manufactured by using the phosphors formed in the Example 1. The voltage to be applied to a high-voltage terminal was set to 7 kV. The signal input terminals Dx1 to Dxm and Byl to Dyn were respectively connected to cathode electrodes and gate electrodes on the rear plate, and signals from a driver were input to the respective terminals. Here, a pulse width was set to 20 psec, a frequency was set to 100 Hz, and an irradiation current density was set to 20 mA/cm².

In the image displaying apparatus using the phosphors of the present invention, the luminance with a state of emitting green light became such the luminance of 210 cd/m², and the luminance required in the image displaying apparatus could be realized. It may be said that the phosphors formed in the present invention are the particulate SrGa₂S₄ phosphors which realize the luminance required in the image displaying apparatus. Therefore, it may be said that a phosphor film, which can realize the luminance required in the image displaying apparatus with the high-definition condition, can be formed by using the phosphors formed in the present invention. In addition, since the luminance of the phosphors formed in the Examples 2 to 8 is higher than the luminance of the phosphors formed in the Example 1, if the phosphors formed in the Examples 2 to 8 are used, it may be said that the luminance of 210 cd/m² or more can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-158607, filed Jul. 13, 2010, which is hereby incorporated by reference herein in its entirety.

What is claimed is:

1. A manufacturing method of a phosphor which includes a host material of thiogallate-based sulfide represented by a general formula AGa₂S₄ (where, A is Ca, Sr or Ba) and an activator, the method comprising:
(a) forming a raw material particle including a constituent component of the host material except a sulfur component and a constituent component of the activator in a composition ratio in the phosphor;
(b) forming an amorphous precursor particle by heating the raw material particle by thermal plasma and cooling the heated raw material particle; and
(c) baking the precursor particle in a sulfurization atmosphere to set a particle size to 1000 nm or less and a crystallite size to 60% or more of the particle size.

2. The manufacturing method according to claim 1, wherein the particle size of the precursor particle obtained in the step (b) is set to 50 nm or less.

3. The manufacturing method according to claim 1, wherein the particle size in the step (c) is set to 1000 nm or less and 300 nm or more.

4. The manufacturing method according to claim 1, wherein Eu is used as the activator.

5. A manufacturing method of an image displaying apparatus in which plural pixels are constituted by phosphors provided to be able to selectively emit light, and which displays an image by causing the pixels to selectively emit light, wherein
the pixels are constituted by the phosphors manufactured by the manufacturing method described in claim 1.

6. A phosphor wherein a particle size is 1000 nm or less, a crystallite size is 60% or more of the particle size, and a host material is thiogallate-based sulfide represented by a general formula AGa₂S₄ (where, A is Ca, Sr or Ba).

7. The phosphor according to claim 6, wherein the particle size is 1000 nm or less and 300 nm or more.

8. The phosphor according to claim 6, wherein an activator is Eu.

9. An image displaying apparatus in which plural pixels are constituted by phosphors provided to be able to selectively emit light, and which displays an image by causing the pixels to selectively emit light, wherein
the pixels are the phosphors described in claim 6.
